(19) United States
(12) Patent Application Publication
(10) Pub. No.: US 2008/0104642 A1
(43) Pub. Date: May 1, 2008

(54) Cabin management and entertainment system

(75) Inventors: Steven R. Galipeau, Redmond, WA (US); Rory G. Briski, Bellevue, WA (US); Gregory P. Adams, Renton, WA (US); James W. Mills, Wylie, TX (US); Joseph G. Martin, Hanalei, HI (US)

Correspondence Address: Steve Galipeau, Suite B, 13200 SE 30th St.,, Bellevue, WA, 98005, US

(73) Assignee: Avion Engineering Services Inc., DBA AvionPartners, Bellevue, WA (US)

(21) Appl. No.: 11/974,086

(22) Filed: Oct. 11, 2007

Related U.S. Application Data
(60) Provisional application No. 60/851,231, filed on Oct. 12, 2006.

(51) Int. Cl. H04N 7/18

(52) U.S. Cl. 725/76

(57) ABSTRACT

An aircraft cabin management system that provides passengers and crew with a number of entertainment and productivity enhancing options. Such options include, without limitation, audio, video, control and status of aircraft data systems and electro-mechanical devices. Located proximate to each seat and in various other strategic locations throughout the cabin is a control unit that acts as the primary means of passenger and crew interaction with the cabin management system. Using a multi-cast distribution methodology, over wired or wireless distribution, allows for an unlimited number of clients to have access to each available audio/video program. This allows the system to be fully scalable from a small 4 seat mobile platform to a large 800+ seat mobile platform. While particularly drawn to aircraft, the cabin management system is also applicable to other venues that have identifiable seating locations such as buses, passenger ships, hotels and auditoriums.

### BACKGROUND OF THE INVENTION

1. Field of the Invention

This invention relates to a system for controlling and managing the control of devices on a mobile platform to a plurality of users, for example, passengers on-board a private or business aircraft.

2. Description of Related/Prior Art

In some audio system embodiments, an audio playback apparatus housed on-board the aircraft reproduces audio programs from optical compact discs (CDs) and/or magnetic audio tapes. The multiple audio programs are converted from digital (on the disc) to analog and then converted back to digital for transmission to individual seat locations or to cabin speakers where a desired audio channel may be selected by passengers or crew.

In some video system embodiments, multi-channel video is similarly available. Multi-channel video is provided by a method analogous to multi-channel audio. A plurality of video programs, either DVD or magnetic tape, are played and their analog outputs are digitally encoded and then transmitted to individual seat locations and bulkhead monitors as selected by passengers or crew.

In addition, in private and corporate/business jets, cabin crew and passengers also have the ability to control the cabin temperature and lighting systems.

Traditionally this could amount to hundreds of items being installed into the aircraft to fulfill these functions. Currently, the systems described above are heavy, displace a large volume of space in the aircraft and degrade audio and video quality by going through many conversions of analog to digital to analog to digital to analog.

There remains, therefore, a need for a cabin management and entertainment system with sufficient flexibility to support and integrate the entertainment and data needs of passengers, and address the system weight and volume constraints of the aircraft manufacturers, both for the present and the future.

3. Objects and Advantages

Accordingly, several objects and advantages of our invention are:

Our CMS provides the truest reproduction to the user of the originally encoded audio and video content when compared to our digital CMS systems.

Our CMS provides the greatest flexibility with regard to system installation options.

The highly integrated nature of our CMS allows it to have the lightest weight, displace the least volume and have the fewest box count of any similar such system.

These features combine to allow aircraft to travel further and to cost less to operate by reducing fuel consumption. It also allows more space within the passenger cabin by displacing less volume than traditional systems. Additionally, with fewer boxes to maintain the system reliability increases while the cost to maintain decreases.

Further objects and advantages of our invention will become apparent from a consideration of the drawings and ensuing description.

4. Brief Summary of Invention

The invention, a cabin management and entertainment system, provides passengers with audio and/or video entertainment options and also controls the cabin environment such as temperature and lighting. Additionally, other aircraft systems, like portable water and waste water, can be monitored and their status provided to the crew.

With regard to audio and video entertainment the CMS Cabin Control Unit includes a plurality of internal DVD/CD optical drives, internal digital memory card readers external analog audio and video inputs, external digital audio and video inputs and associated control mechanisms.

The audio and video distribution is multicast using Internet Protocol TV (IPTV) standards.

Using a multi-cast distribution methodology, over wired or wireless distribution, allows for an unlimited number of clients to have access to each available audio/video program. The bandwidth utilization of one person viewing a movie or 1,000 people watching the identical movie is the same. This allows the system to be fully scalable from a small 4 seat mobile platform to a large 800+ seat mobile platform.

In order to conserve bandwidth in a wireless system, the multicast audio/video is not transmitted beyond the Wireless Access Point unless there is a client that has requested this content. For example, if there are 5 operating video channels (3 DVD's playing plus a moving map video plus an input from an external video camera), and if there are only 2 clients on-board viewing video, a maximum of two of the above 5 video sources would actually be being transmitted through the Wireless Access Point, thereby increasing the overall video quality. Because, as the number of transmitted video channels goes down the available bandwidth for each goes up which allows more information within each video signal to be transmitted.

Typical audio functional path:
Audio content is available from a variety of sources including:
   CD/DVD installed in one of the optical drive bays
   MP3 audio via the MP3 card reader
   External analog audio sources
All of the audio sources are encoded, placed on a data channel per the configuration requirement of the user and sent to either the Data Switch Unit for wired distribution throughout the cabin or to the Wireless Access Point for Wireless distribution or to both.
The Passenger Control Unit will receive the signal and decode it from its digital form and convert it to analog and route it to the passenger's headset.
If the audio is to be presented on the cabin speakers, the audio will be decoded by the Audio/Video Decoder Unit and sent to the cabin audio amplifier.
Essentially the audio remains in digital format until it reaches its destination where it is then converted to analog and presented to the passengers.

Typical bulkhead video functional path:
Multiple sources of Video are possible, DVD players, Moving map video content, etc.
In the case of a DVD, the digital video is transcoded from the DVD-Video Object (VOB) files MPEG2 format to MPEG4 and is sent to the Data Switch and/or wireless access point for distribution to the Audio/Video Decoder Units (VDU).
The VDU will decode the video and send it to the monitors for display.
Video channel selection for the bulkhead monitor can be made via:
   Flight Attendant Control Panel (local and/or remote)
   Passenger Control Unit (PCU)
   Remote Control Unit (if the option is installed)>
Essentially the video remains in digital format until it reaches its destination where it is then converted to a signal viewable to the passengers.

Typical In-Seat video functional path:
Multiple sources of Video are possible, DVD players, Moving map video content, etc.
In the case of a DVD, the digital video is transcoded from the VOB files MPEG2 format to MPEG4 and is sent to the Data Switch and/or wireless access point for distribution to the Passenger Control Units.
The Passenger Control Units will decode the video and send it to the monitor for display.
Video channel selection for the in-seat monitor can be made via:
   Passenger Control Unit
   Flight Attendant Control Panel (can force all monitors to play the same video program)>
Essentially the video remains in digital format until it reaches its destination where it is then converted to a signal viewable to the passengers.
   4.1 System Overview

The backbone of this system is an Internet Protocol (IP) based network that supports multiple dissimilar data traffic such as:
Multi-channel Video
Multi-channel Audio
Internet Protocol (IP) Telephony
Voice over Internet Protocol (VoIP)
Environmental Controls
Cabin Controls (lighting, window shades, other)
Passenger Local Area Network
   For Internet and Intranet
System status monitoring, etc.

The CMS system is designed for maximum flexibility and can accommodate either an installation that is predominantly wired in nature or wireless depending upon its final application and functionality required in the aircraft cabin.

4.2 General

The CMS can interface to the following standard equipment, if installed:
Satellite Radio System
Satellite Television System
Off-Aircraft Communication Systems
   Satellite Communication System (SATCOM)
      For example: Inmarsat or Iridium
   Terrestrial based systems
      For example: North American Telephone System (NATS)>
Cabin Lighting
Cabin Temperature Controllers
Cabin Audio System
Water Level Indicators
Window Shade and Door Controllers
The CMS can be implemented with virtually any custom interface required within the aircraft
   4.3 Level of Integration

The CMS is the most highly integrated system available. It follows a modular concept integrating several subsystems, (e.g. Moving Map, CD/DVD players, etc.), that normally require separate Line Replaceable Units (LRUs).

The CMS provides numerous integration benefits, such as:
Smallest form factor in the industry
Lightest weight
Smallest system volume
Minimal number of wires
Minimal operating costs
Minimal number of LRUs
Maximum interchangeability
Thorough built-in-test capability
Ease of Installation
   4.4 System Features

The CMS has an extensive feature set including:
Customized bezels and panels can be made to match the aircraft interior
Bright, high-resolution LCD control displays
Intuitive Graphical User Interface (GUI)
Low end-item parts count
Customizable enunciator and cabin control switch panels
Low power consumption
Reduced maintenance
No forced aircraft provided air cooling is required
GUI is reconfigurable to support customer changes
Integrated source equipment
   Multiple DVD players
   MP3 memory card reader available
   Optional Integrated Moving Map
Flight Attendant Call/Chime
Optional Support for external equipment interfaces
   Apple iPOD interface (Audio, Control and Power/Recharge)
   3rd party analog sources
      External viewing cameras
      Personal camcorders
      Video Cassette Recorders/Players (VCR)
      CD Players
      MP3 Player
   Satellite Radio
   Satellite TV
Optional Boarding Music
PA Keyline interface to pause A/V content
Optional Macro commands to set cabin mood and ambience with a single button
The GUI on each of the display controls is field loadable which allows for a minimal number of hardware part numbers.

### DRAWINGS/LIST OF FIGURES

A note about the included figures:

The figures included herein show system installations on an 8-seat vehicle. This is for ease of description and is not meant to restrict or otherwise limit the application of the invention to a specific number of seats.

FIG. 1 Simplified Block Diagram of the Audio/Video distribution in a wireless configuration for an 8-seat installation

FIG. 2 Simplified Audio/Video Data Flow (Wireless)

FIG. 3 Simplified Block Diagram of the Audio/Video distribution in a wired configuration for an 8-seat installation

FIG. 4 Simplified Audio/Video Data Flow (Wired)

FIG. 5 Simplified Audio/Video Data Software Flowchart

FIG. 6 Cabin Control Unit

FIG. 7 Cabin Control Unit Block Diagram

FIG. 8 Cabin Control Unit Encoder/Transcoder Card Block Diagram

FIG. 9 Cabin Control Unit I/O Card Block Diagram

FIG. 10 Flight Attendant Control Panel Block Diagram

FIG. 11 Single Switch Panel Block Diagram

FIG. 12 Common Receiver Unit

FIG. 13 Data Switch Unit Block Diagram

FIG. 14 Wireless Access Point Block Diagram

FIG. 15 Optical Drive Bay Block Diagram

### DRAWINGS

### List of Reference Numbers

The reference numbers use 3 or 4 digit numerals.

The first 1 or 2 digits=the figure number and the second 2 digits indicate the part number

### ITEM NOMENCLATURE

102 Cabin Control Unit (CCU)
104 Flight Attendant Control Panel
106 CCU Optical Drive Bay
108 Passenger Control Unit (PCU): Wireless
110 In-Seat Video Recepticle
112 Audio Headset Analog
114 Wireless Access Point (WAP)
116 Wireless Access Point Antennas
118 Cabin Switch Panel (CSP): Wireless
120 Single Switch Panel
122 AudioNideo Decoder Unit (VDU): Wireless
124 Cabin Bulkhead Monitor
126 Cabin Audio Amplifier
128 Enunciator Panel Wireless
130 Remote Control Unit
302 Passenger Control Unit (PCU): Wired
304 Data Switch Unit
306 Cabin Switch Panel (CSP): Wired
308 AudioNideo Decoder Unit (VDU): Wired
310 Enunciator Panel: Wired
602 CCU cPCI Card Cage
604 CCU Cooling Fans
606 CCU Power Supply
610 CCU Hard Drive
612 CCU Main Processor Card
614 CCU Avionics i/o Card
616 Processor Card for Moving Map Option
618 CCU Encoder/Transcoder Card
620 CCU Environmental Controller Card
622 CCU Main Power Input
624 Ethernet Ports
626 USB 2.0, USB 1.1 and +12 Vdc Power Connector
630 External Optical Drive Bay Connector
632 CCU cPCI Backplane
634 CCU Chassis
636 Optical Disk Drive
638 Memory Card Reader
640 CCU Fan Control Logic
642 Flight Attendant Call Chime Speaker
644 CCU Power Out Circuit Breaker
646 Hard Drive for Moving Map Option
802 CCU Encoder/Transcoder Card: Computer-on-Module
814 CCU Encoder/Transcoder Card: Input Connector
906 IndustryPack (I.P.) Module Interface
1032 Flight Attendant Control Panel: Display & Touch-Screen
1202 Common Receiver Unit: Computer-on-Module
1204 Common Receiver Unit: Display
1206 Common Receiver Unit: Touch-Screen
1210 Common Receiver Unit: Hard-Switch (Optional)
1214 Common Receiver Unit: Local Relays
1222 PCU: Power Out for Noise Cancelling Headset
1226 Common Receiver Unit: Analog Audio Output
1228 PCU: Hard-Volume Control (Optional)
1232 Common Receiver Unit: Radio
1236 Common Receiver Unit: Antenna
1238 PCU USB Port
1302 Data Switch Unit: Power Supply
1304 Data Switch Unit: Multi-Port Ethernet Switch

### DETAILED DESCRIPTION

### Preferred Embodiment (Wireless)

As the cabin Management and Entertainment System is comprised of multiple units, each unit will be described in turn.

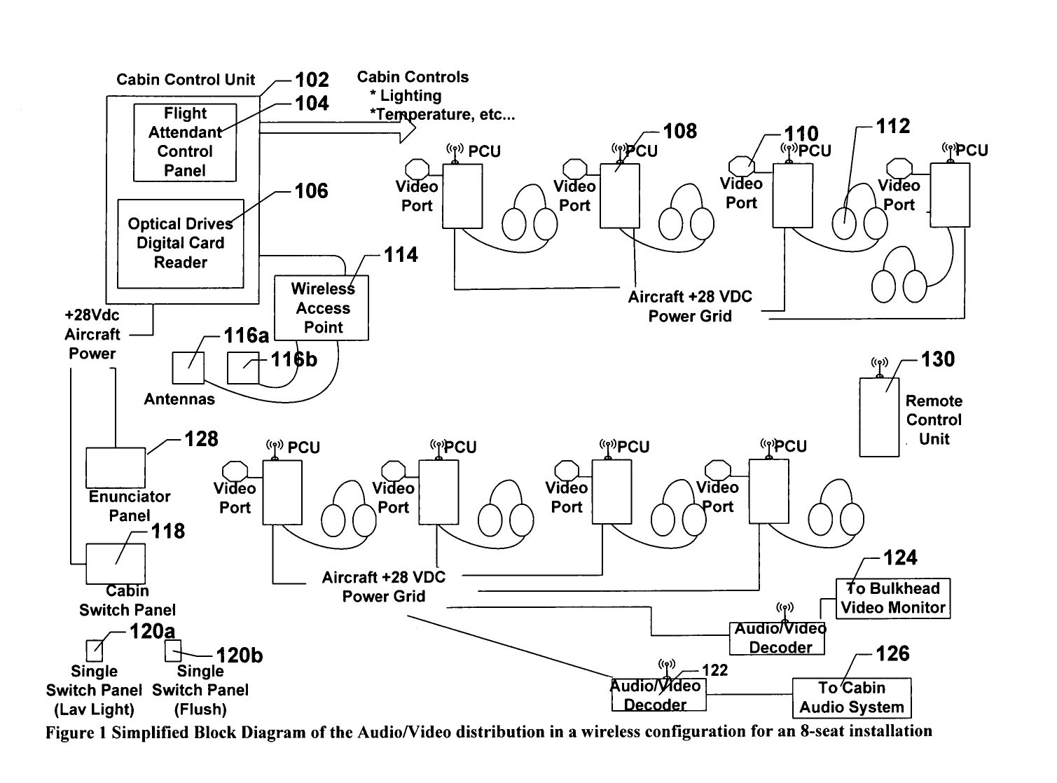

FIG. 1 illustrates the general system interconnects for an 8-seat configuration and should be used as the overall reference for this section.

Cabin Control Unit

FIG. 6 shows the elements that make up the Cabin Control Unit (CCU).

Physical Assembly:
The CCU 102 is based around a modular rack concept provided by Compact Peripheral Component Interconnect (cPCI).
It contains a plurality of cPCI circuit cards of a type and function dependent on the final configuration of the system. See FIG. 6 for an example.
At a minimum, the CCU would contain the following cards:
   One Main Processor Card 612
   At least one Encoder/Transcoder Card 618
   At least one Environmental Controller Card 620
Power Supply 606
   cPCI Card Cage 602 and cPCI Backplane 632

A chassis 634 houses a 3U nine slot cPCI card cage 602 and cPCI backplane 632. A hard drive 610 is mounted to the cPCI card cage 602 and connects to a main processor card 612 through the cPCI backplane 632. A Flight Attendant Control Panel 104 attaches to the chassis 634 and connects to the main processor card 612 through the cPCI backplane 632. Cards that give functionality to the system 612, 614, 616, 618 and 620 are inserted into the cPCI card cage 602 and are thereby plugged into the backplane 632.

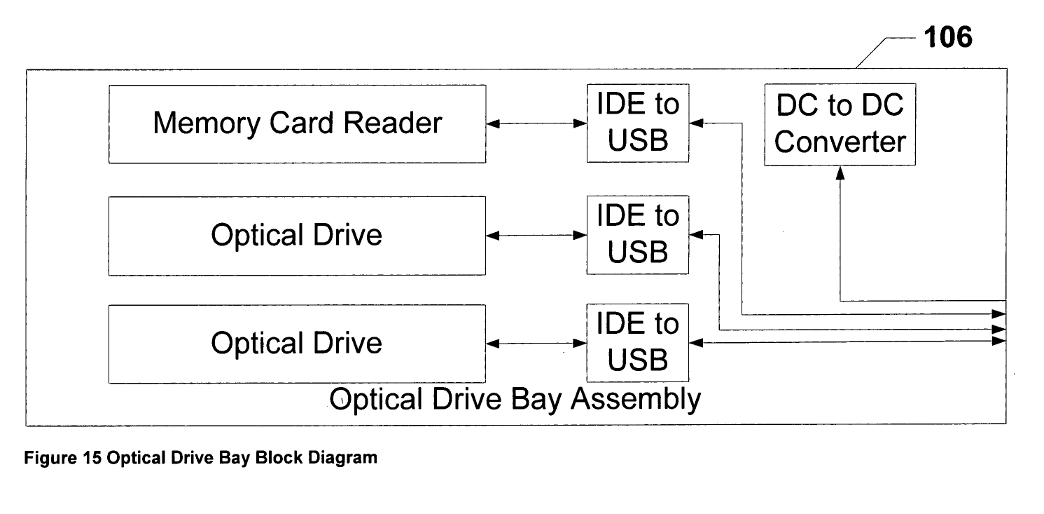

An optical Drive Bay 106 houses two optical drives 636a & 636b and a computer memory card reader 638. Reference FIG. 15. The Optical Drive bay is also housed within the chassis 634. A power supply 606 converts the input power to the necessary voltages and currents.

A remote optical drive assembly connector 630 is mounted on the rear of the chassis 634 and is used to provide an interface between the Encoder/Transcoder cards 618 and an externally mounted Optical Drive bay 106 if installed.

Cooling fans 604a and 604b are located on the bottom of chassis 634, while the fan control logic 640 is mounted to the backplane 632.

Two Ethernet connection ports 624a & 624b are mounted on the rear of the chassis 634 and provide the interface to external devices from the Avionics I/O card 614 via the backplane 632.

The Ethernet ports 624a and 624b are Radiall 96-0132-048.

A connector 626 is mounted on the rear of chassis 634 and is connected to the Avionics I/O card 614 via the backplane 632 to carry USB 2.0. It is also connected to the main processor card 612 via the backplane 632 to carry USB 1.1 and is further connected to the power supply to provide +12 Vdc out to peripherals.

A main power input 622 is mounted on the rear of chassis 634 and is connected to power supply 606.

Flight Attendant Chime Speaker 642 is mounted to the Flight Attendant Control Panel 104 and is also connected to Control Panel 104 audio output.

External 12 Vdc output from the power supply 606 is connected to circuit breaker 644 which is in turn connected to external optical drive connector 630 and connector 626.

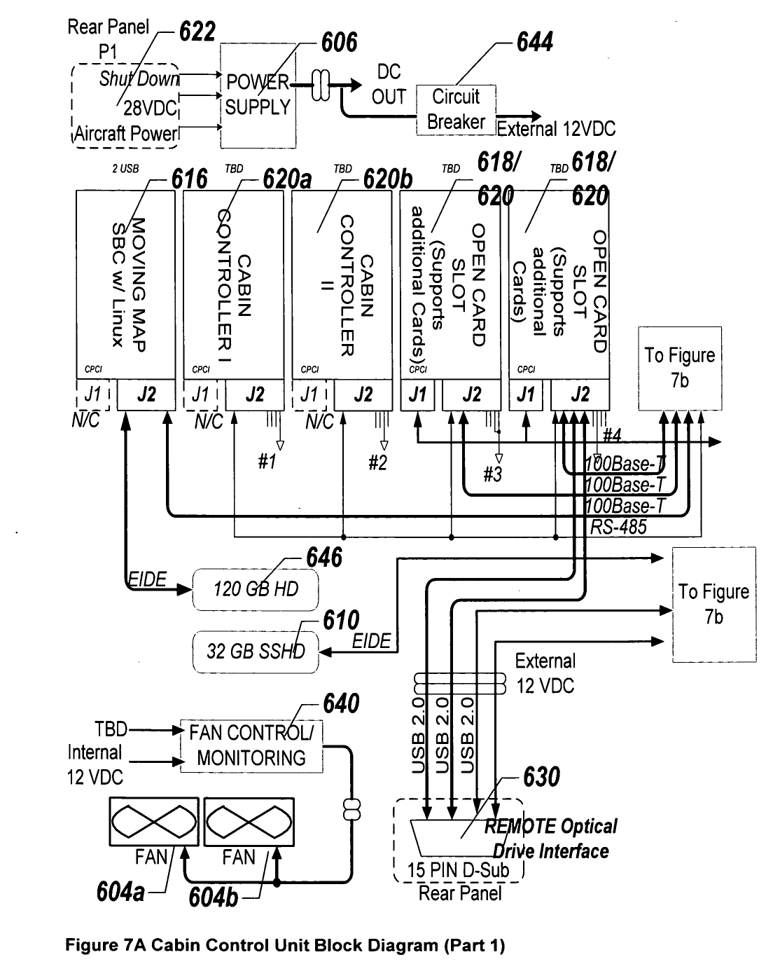

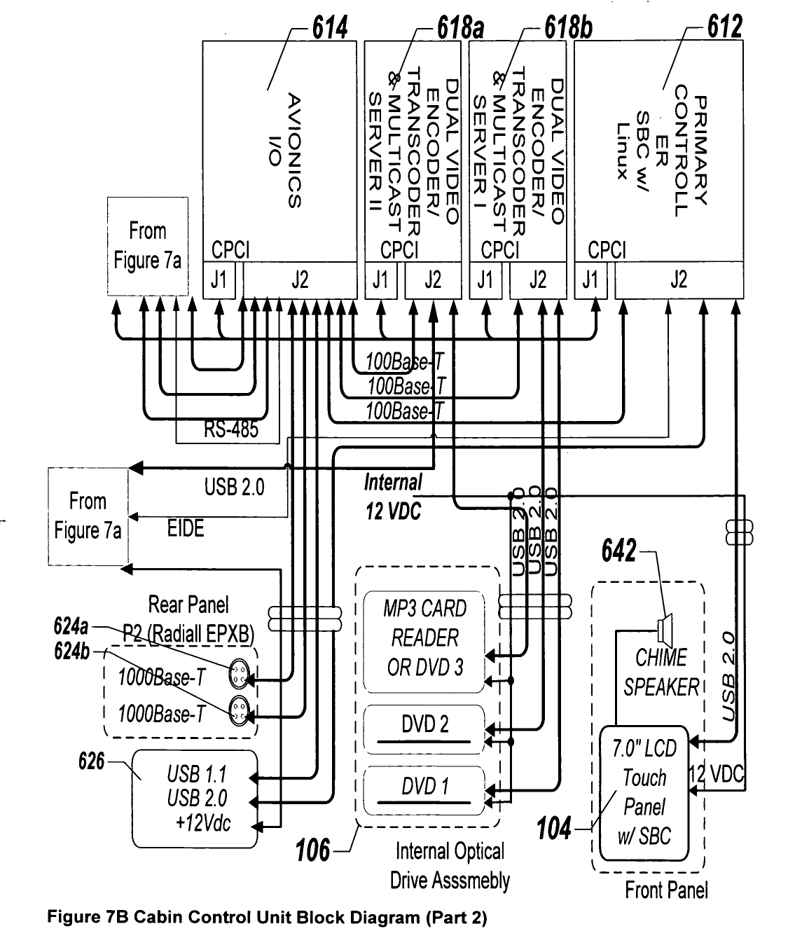

FIG. 7 illustrates how the various modules and components within the CCU 102 are interconnected.

Cabin Control Unit Main Processor Card Description

FIG. 6 card 612 shows the Main Processor card. This card is an industry standard 3U cPCI computer card and can contain various types of processors, I/O, memory and other interfaces. There are many manufactures of these types of computer cards. The card we selected for our application is the Kontron CP306, however many different cards could work in this application.

Cabin Control Unit Encoder/Transcoder Card Description

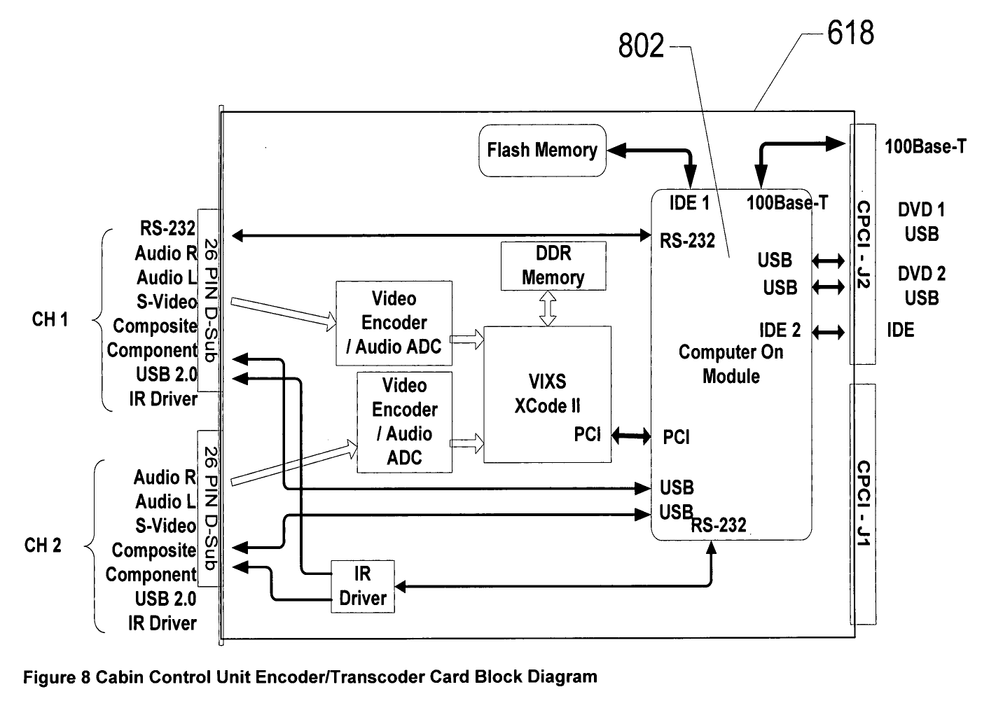

FIG. 8 card 618 shows the Encoder/Transcoder card. This card is built to conform to the industry standard 3U cPCI form factor.

A computer-on-module 802 is an industry standard ETX form factor computer card and can contain various types of processors, I/O, memory and other interfaces. There are many manufactures of these types of computer cards. The card we selected for our application is the Kontron ETX-PM, however many different cards could work in this application.

General sub-modules, signal inputs and signal outputs for this card are clearly shown.

Cabin Control Unit Avionics I/O Card Description

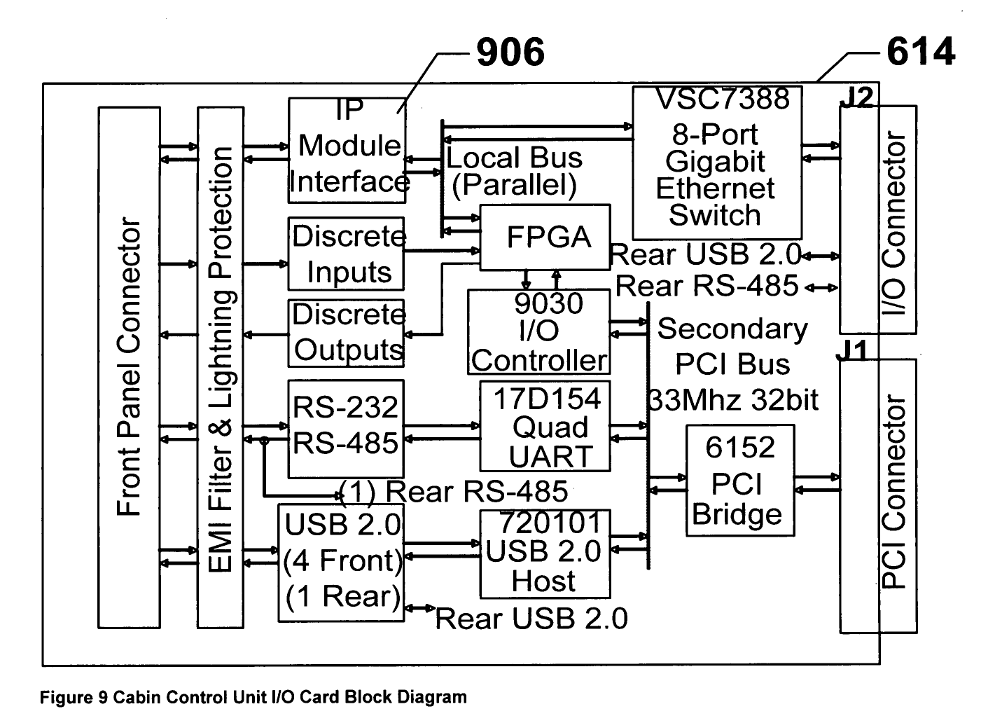

FIG. 9 card 614 shows the Avionics input/output card. This card is built to conform to the industry standard 3U cPCI form factor.

IP Module interface 906 is the mating half to numerous industry standard IP Modules which are utilized for various input/output interfaces such as ARINC429 communication.

General sub-modules, signal inputs and signal outputs for this card are clearly shown.

Cabin Control Unit Environmental Controller Card Description

FIG. 33 card 620 shows the Environmental Controller card. This card is built to conform to the industry standard 3U cPCI form factor.

General sub-modules, signal inputs and signal outputs for this card are clearly shown.

Wireless Access Point Description

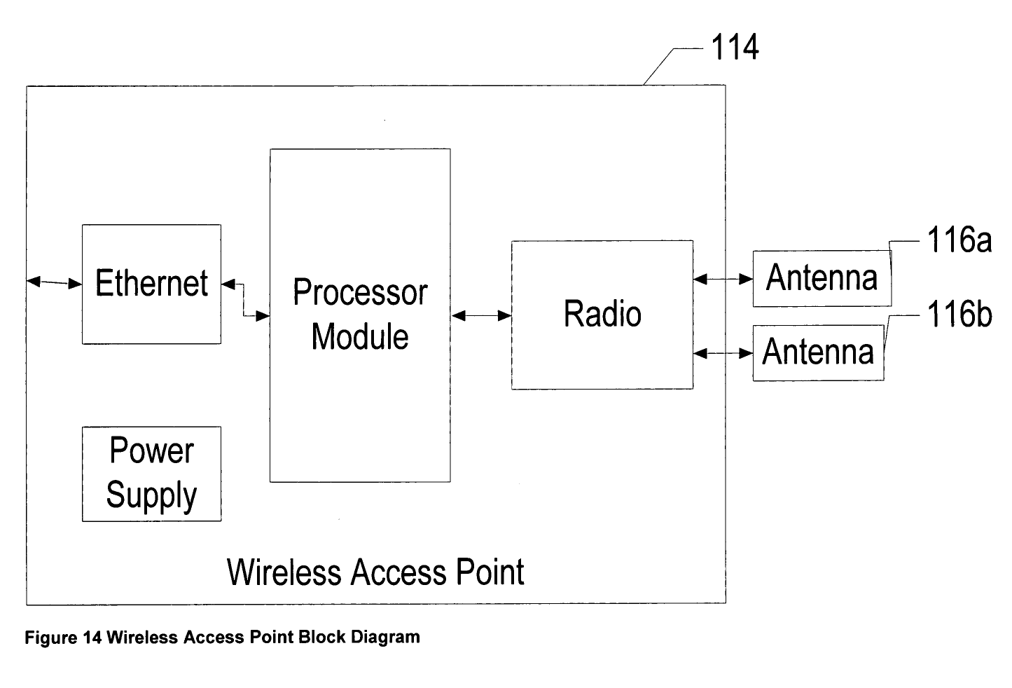

FIG. 14 shows a Wireless Access Point 114

This is an industry standard Wireless Access Point with the capability of interfacing with two to four external antennas 116.

General sub-modules, signal inputs and signal outputs for this unit are clearly shown.

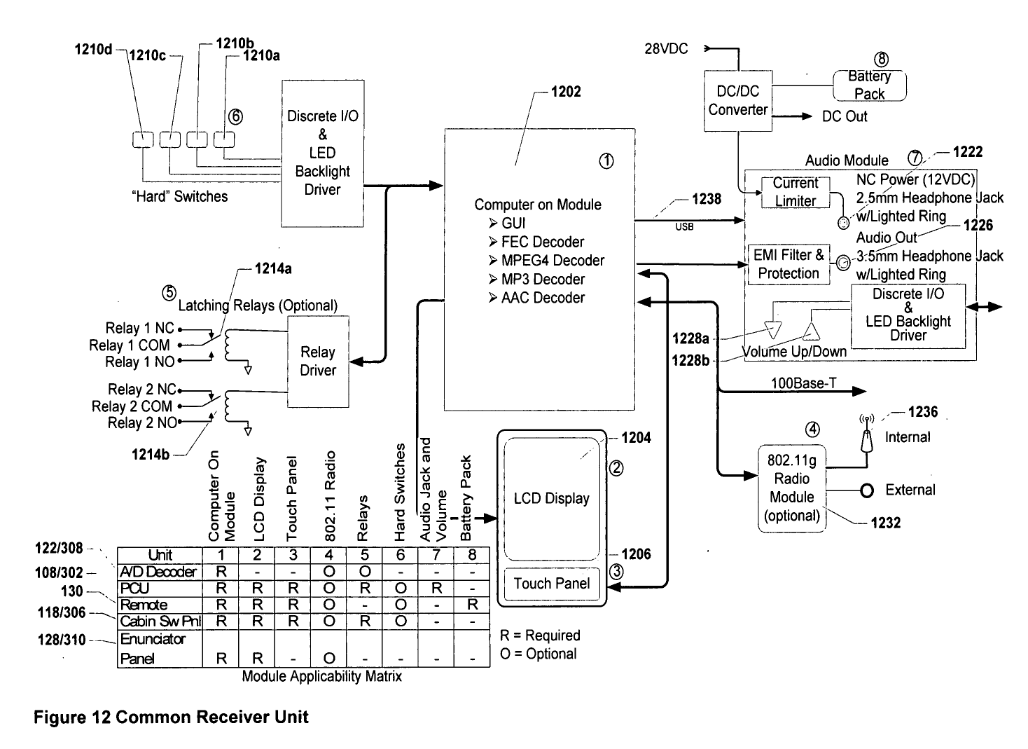

FIG. 12 shows Common Receiver Unit circuitry for Passenger Control Unit 108, Cabin Switch Panel 118, Audio/Video Decoder Unit 122, Enunciator Panel 128 and Remote Control Unit 130.

Computer-on-module 1202 can be any one of a variety of common circuit boards of this type.

For our application we are using a Compulab CM-X270, however many different cards could work in this application.

General sub-modules, signal inputs and signal outputs used in each variant of this entity are clearly shown. The list of which module is used in each variant is shown in the Module Application Matrix also in FIG. 12.

Single Switch Panel

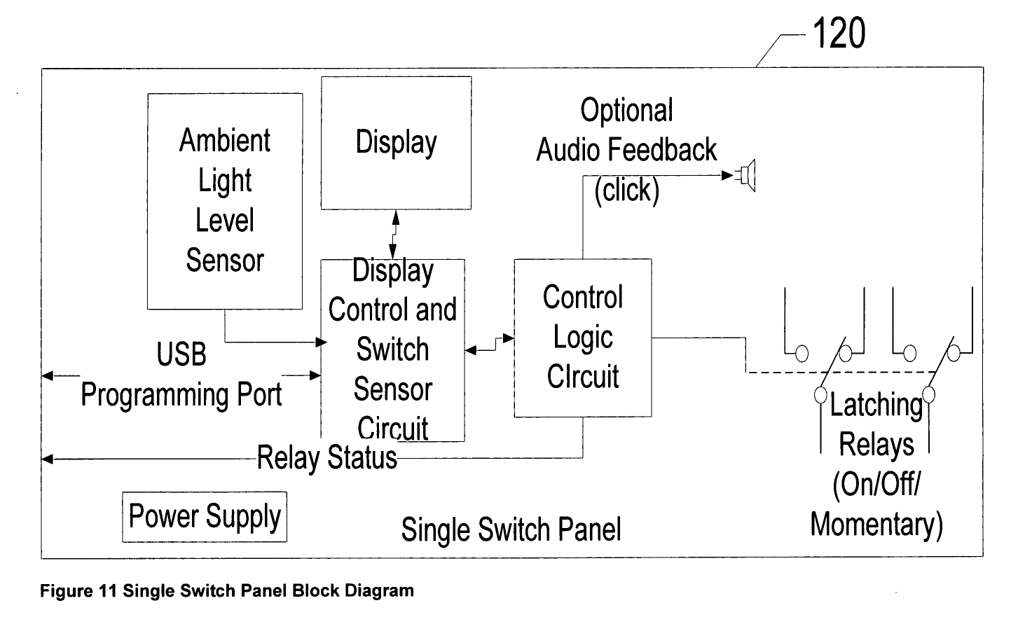

FIG. 11 shows the block diagram for the Single Switch Panel 120.

General sub-modules, signal inputs and signal outputs for this module are clearly shown.

Flight Attendant Control Panel

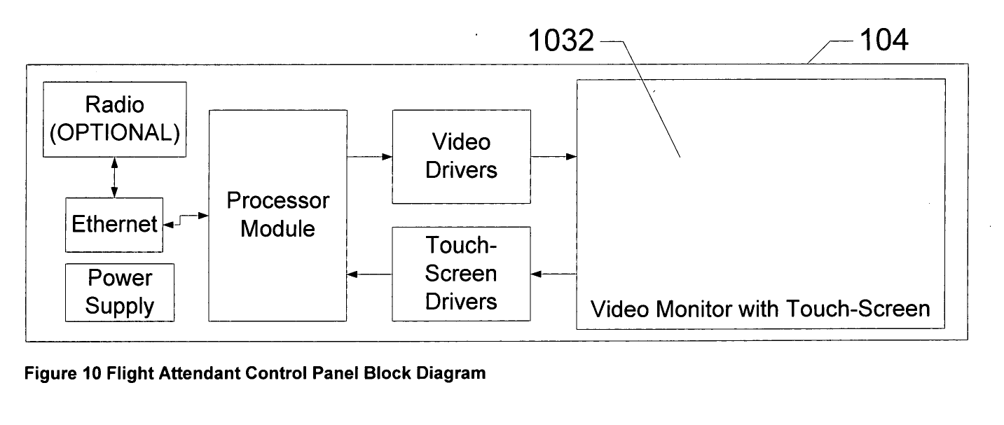

FIG. 10 shows the block diagram for the Flight Attendant Control Panel 104.

General sub-modules, signal inputs and signal outputs for this module are clearly shown.

### OPERATION OF INVENTION

### Preferred Embodiment (Wireless)

5. Wireless System Overview

The CMS can be configured for wireless Audio/Video distribution. In this embodiment the Passenger Control Units (PCU) 108, Cabin Switch Panels (CSP) 118, Enunciator Panel 128, Remote Control Unit 130 and Audio/Video Decoder Units (VDU) 122 communicate with the Cabin Control Unit (CCU) 102 via the Wireless Access Point 114 over an IEEE802.11 (WiFi) radio network. The environmental controls remain as wired interfaces to the lighting, heating/cooling systems, window shade control and other such systems.

5.1 Audio Distribution (wireless)

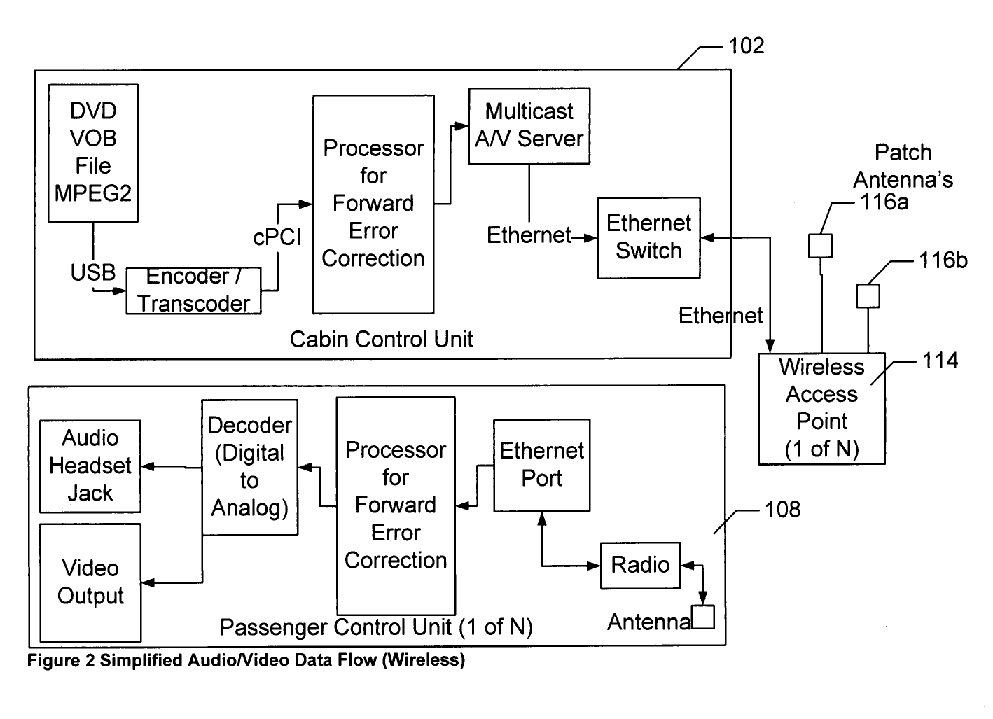

See FIG. 1 and FIG. 2.

Audio distribution is accomplished using a multicast network and Internet Protocol Television (IPTV) standards.

The network distributes encoded digital audio data from a variety of source equipment to a plurality of clients where it is decoded and presented to the user.

Typical audio functional path:
Audio content is available from a variety of sources including:
   MP3 CD/Audio CD/DVD installed in one of the optical drive bays 706
   MP3 audio via the MP3 card reader 708
   External analog audio sources connected through input 814
All of the audio sources are encoded 618, channelized per the configuration requirement of the user 612 and processed for Forward Error Correction 802 and then sent to the Wireless Access Point 114 where the data streams terminate until such time as the WAP 114 receives a stream request from a PCU 108, Remote Control 130 or Flight Attendant Control Panel 104.
   After a stream request is received the WAP 114 broadcasts the stream throughout the cabin for any PCU or VDU to receive.
The Passenger Control Unit 108 will receive the signal 1232 and decode it from its digital form and convert it to analog 1202 and route it 1226 to the passenger's headset 112.
If the audio is to be presented on the cabin speakers, the audio will be received by and decoded by the audio/video decoder unit 122 and sent to the cabin audio amplifier 126.
External audio signals follow a similar path entering the system at 814 and then following the path as previously described.

A note about channelization, channelization is merely the manner in which the audio content has been stored. A file directory structure by genre such as Rock, Country, Jazz with the types of music files stored in them will have these genre titles appear in the GUI menus of the PCU 108, Control Panel 104 and Remote Control 130. If the file directory is structured by album name or artist name at the root level, then those descriptors would show up as channels on the PCU 108, Control Panel 104 and Remote Control 130.

5.2 Video Distribution (Wireless)

See FIG. 1 and FIG. 2.

Decoding of the audio and video content is built into the Passenger Control Units (PCU) 108 and Audio/Video Decoder Unit (VDU) 122. For in-seat video, the Video Port 110 is wired from the PCU.

5.2.1 Bulkhead Video

Typical bulkhead video functional path:
Multiple sources of Video are possible including:
   DVD players 636, Moving map 616, etc.
   External analog video sources such as wing camera's connected through input 814
In the case of a DVD, the digital video is read from drive 636 and carried over USB to Encoder/Transcoder card 618 where it is transcoded from MPEG2 to MPEG4 and is processed for Forward Error Correction 802 and then sent to the Wireless Access Point 114 where the data streams terminate until such time as the WAP 114 receives a stream request from Passenger Control Unit 108 or Remote Control Unit 130
   After a stream request is received the WAP 114 broadcasts the stream throughout the cabin for any PCU 108 or VDU 122 to receive.
The Video Decoder Units 122 will decode the video and send it to the monitors 124 for display.
Video channel selection for each bulkhead monitor can be made via:
   Flight Attendant Control Panel 104
   Passenger Control Unit 108
      Typically only one PCU per aircraft has the functionality to control the cabin monitors enabled.
   Remote Control Unit 130
External video signals follow a similar path entering the system at 814 and then following the path as previously described.
   5.2.2 In-Seat Video

Typical In-Seat video functional path:
Multiple sources of Video are possible including:
   DVD players 636, Moving map 616, etc.
   External analog video sources such as wing camera's connected through input 814
In the case of a DVD, the digital video is read from drive 636 and carried over USB to Encoder/Transcoder card 618 where it is transcoded from MPEG2 to MPEG4 and is processed for Forward Error Correction 802 and then sent to the Wireless Access Point 114 where the data streams terminate until such time as the WAP 114 receives a stream request from a PCU 108.
   After a stream request is received the WAP 114 broadcasts the stream throughout the cabin for any PCU 108 or VDU 122 to receive.
The Passenger Control Units 108 will decode the video and send it to the video port 110 where the monitor is plugged in.
Video channel selection for the in-seat monitor can be made via:
   Passenger Control Unit 108
   Flight Attendant Control Panel 104
      The Flight Attendant Control Panel 104 can also command all monitors to simultaneously play the same video program
External video signals follow a similar path entering the system at 814 and then following the path as previously described.
   5.2.3 AudioNideo Software Data Flow

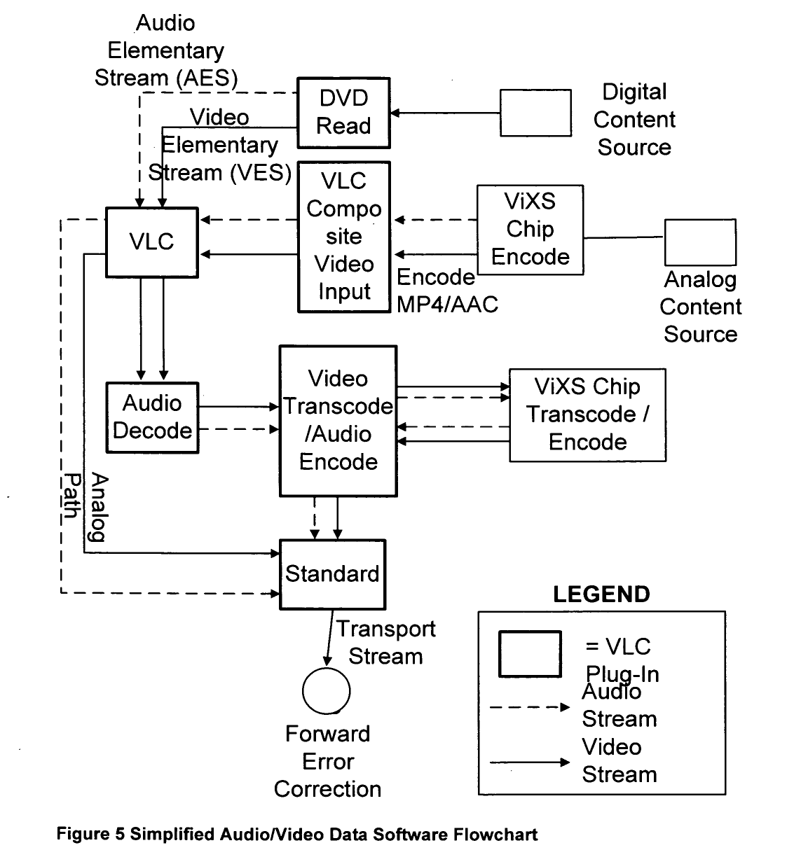

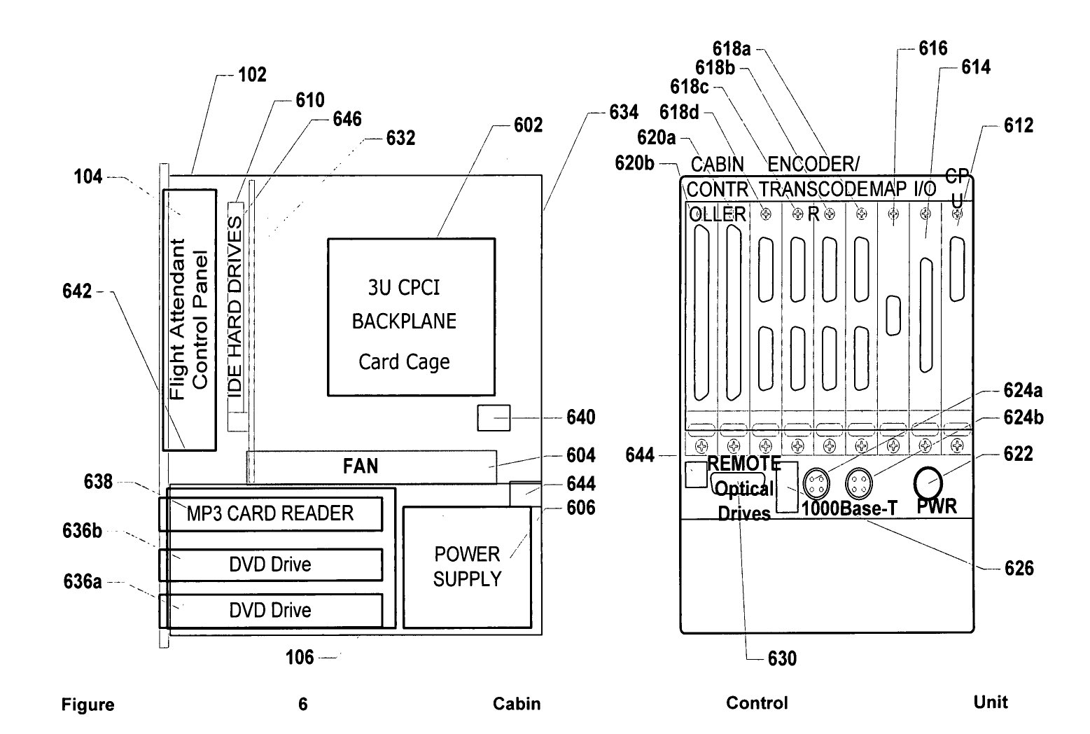

FIG. 5 illustrates the general software flow of the audio/video content and how it gets from its source state to a state that can be broadcast through the wireless system.

5.3 Command Control Flow (Wireless)

Icons and text are presented to the user via the PCU 108 display 1204. The user either presses on the touch-screen 1206 or presses one of the optional hard-switches 1210 or optional volume controls 1228. The processor 1202 then evaluates the command and determines what action to take. With regard to audio and video channel selection, the processor 1202 sends an IP address request, which corresponds to the channel that the user wants, to the WAP 114 which in turn broadcasts the stream throughout the cabin for any PCU 108 or VDU 122 to receive.

With regard to audio volume control, this is handled locally by the processor 1202 in response to user input.

With regard to cabin environmental commands, the user presses the touch-screen 1206 or optional hard-switch 1210 then the processor 1202 sends a corresponding command to the CCU 102 via the WAP 114 to alert the Main Processor 612 as to which icon or text was selected by the user. The main processor then forwards a command on to the appropriate Controller Card 620 which then operates the appropriate relay or potentiometer or other mechanism to carry out the users command.

With regard to local lighting or electrical device control, PCU 108 is equipped with two independent relays 1214 for operating devices in close proximity to the PCU 108.

Additionally, icons and text are presented to the user via the Control Panel 104. The processor 1026 then evaluates the command and determines what action to take. With regard to cabin audio and video channel selection, the processor 1026 sends a command to the appropriate VDU 122 to change their output state to the desired channel. The VDU then issues an IP address request, which corresponds to the channel that was selected, to the WAP 114 which in turn broadcasts the stream throughout the cabin for any PCU 108 or VDU 122 to receive it.

With regard to cabin environmental commands, the user presses the touch-screen 1032 then the processor 1026 sends a corresponding command to the main processor 612 via USB to alert the Main Processor as to which icon or text was selected by the user. The main processor then forwards a command on to the appropriate Controller Card 620 which then operates the appropriate relay or potentiometer or other mechanism to carry out the users command.

Also, icons and text are presented to the user via the Cabin Switch Panel 118. The processor 1202 then evaluates the command and determines what action to take. With regard to cabin audio and video channel selection, the processor 1202 sends a command to the appropriate VDU 122 to change their output state to the desired channel. The VDU then issues an IP address request, which corresponds to the channel that was selected, to the WAP 114 which in turn broadcasts the stream throughout the cabin for any PCU 108 or VDU 122 to receive it.

With regard to cabin environmental commands, the user presses the touch-screen 1206 then the processor 1202 sends a corresponding command to the CCU 102 via the WAP 114 to alert the Main Processor as to which icon or text was selected by the user. The main processor then forwards a command on to the appropriate Controller Card 620 which then operates the appropriate relay or potentiometer or other mechanism to carry out the users command.

With regard to local lighting or electrical device control, CSP 118 is equipped with two independent relays 1214 for operating devices in close proximity to the CSP 118.

5.4 System Components (Wireless)

5.4.1 Cabin Control Unit

The Cabin Control Unit 102 is a complete Audio/Video distribution unit including source equipment all integrated in one small, light weight and attractive unit. All Audio/Video content is multicast on encoded data streams capable of supporting a virtually limitless number of clients and seats.

Some of the features include:
May include a plurality of optical drives 636 fully integrated into the front panel
   FIG. 15 shows the block diagram of how signals are routed from the device.
May include one MP3 Card Reader 638 fully integrated into the front panel
All DVD/CD digital content is directly transcoded to MPEG4—never converted to analog then back to digital thus providing the highest quality signal
All basic program memory is oh solid state memory modules increasing reliability
Preferred embodiment is 2 Encoder/Transcoder cards which provide 2 A/V inputs each for a total of 4 A/V channels. In the basic configuration:
   Two are typically used for the CD/DVD players 706
   One is typically used for the MP3 Card Reader 708
   One can be used for other analog Audio/Video inputs 814
Full built-in-test and diagnostic tools
Preferred embodiment is with 2 environmental controller cards 620 for Integrated Cabin and Environmental Controls
   Reference FIG. 33, each of the two Environmental Controller Card 620 provides:
      8 Power Relays (5 Amp)(28 Vdc/115 Vac)
      16 Power Relays (2 Amp)(28 Vdc/115 Vac)
      2 Digitally Controlled Potentiometers
      4 Digitally Controlled Reference Voltages
      16 Discrete Inputs
      16 Open Collector Outputs (400 ma)
      8 PWM Control Circuits
         5.4.1.1 Flight Attendant Control Panel

Flight Attendant Control Panel 104 consists of a display with a touch-screen overlay, typically 7″ widescreen. The Flight Attendant Control Panel interface to the user is via display 1032 presenting the Graphical User Interface (GUI).

Typical functions that are selectable via the touch-screen interface include but are not limited to:
Cabin services control
   Temperature control
   Cabin Lighting
   Reading lights
   Table lights
   Window Shades
Entertainment
   Audio control
   Video control
Maintenance status and test
Macro Commands

Sometimes it is desirable to have several functions activated by a single command. For example, if there is a switch labeled “Theatre” it could simultaneously lower the window shades, dim the lights, tune the video monitors to a specific video channel, tune the cabin audio speakers to a specific audio channel and start the video program. Any combination of commands can be activated by a single switch press via macro commands in the system. Macro commands can be implemented on any control device in the CMS including the Flight Attendant Control Panel 104, the Passenger Control Units 108, and the Cabin Switch Panels 118.

5.4.1.2 CCU Environmental and Lighting Control

The Cabin Control Unit (CCU) 102 provides a variety of lighting and environmental control features including:
Controls for lamps and mood lights
Lighting status commands can be displayed on the flight attendant control panel 104
Control of cabin temperature
Control of electrical and electronic window shades
Control of any electrical or motorized device in the passenger cabin

The typical command flow for lighting or environmental control is:
Passenger selects a command from their PCU 108. For Example: “Cabin Light ON”
The PCU sends the command over the wireless network to the Wireless Access Point 114 which in turn forwards the command to the Cabin Control Unit 102.
The Cabin Control Ethernet Switch 926 sends the command to the main processor 612 for interpretation
The main processor sends a command to the appropriate Environmental Control Card 620 and the appropriate relay that drives the particular circuit is enabled for the desired function. For example: Cabin Light “ON” Circuit is energized.
The Cabin Light then turns ON.
Other lighting commands and temperature commands are handled in similar fashion.
There are several different types of circuits being controlled. For example some types include but are not limited to:
   ON/OFF
   ON/OFF/DIM
   ON/OFF/Progressive DIM
   Pulse Width Modulated
   Variable Voltage
   Variable Resistance
      5.4.2 Wireless Access Point (WAP)

The WAP 114 shown in FIG. 14 is a small form factor and low power wireless access point for use with the CMS. It is designed to be powered by the Cabin Control Unit 102 and is connected via 624 on the back of the CCU 102. For optimal performance the WAP utilizes two patch antennas 116.

Features:
Power and data are provided by the Cabin Control Unit via Power over Ethernet (PoE) 624 to facilitate easy installation
Dual radio modules 1404 allow for up to two independent wireless networks to operate simultaneously
Each radio module has dual antenna connections to incorporate redundant antenna processing technology and to increase bandwidth
Supports all standard encryption methods for enhancing network security
Radio modules 1404 are industry standard mini-PCI form factor and may be easily upgraded in the future to take advantage of new wireless standards
   5.4.3 Single Switch Panel

FIG. 11, Single Switch Panel 120 is a compact, versatile and easily customizable Single Switch Panel (SSP). It is primarily designed for locations where only a single switch function is desirable, such as toilet flush or entry-way lighting. This switch is not typically connected to be under the control of the network but it can optionally be wired to provide switch status information to the Cabin Control Unit. The unit display 1102 utilizes the latest advances in display technology which could include an Organic Light Emitting Diode (OLED) color screen for brilliant graphics and high visibility/legibility.

5.4.3.1 SSP Features

Features:
User interface graphic is quickly loaded via USB 2.0
Unit provides for an “ON” graphic as well as an “OFF” graphic.
Any graphic, any language, any image can be used as a GUI button
1 or 2 Power Relays (2 Amp)(28 Vdc/115 Vac)
   5.4.3.2 AudioNideo Decoder Unit (VDU) (Wireless)

See FIG. 12.

The VDU is a compact Audio/Video Decoder Unit (VDU) that is used to provide audio and/or video to external equipment.

Features:
Compact size allows the unit to be easily installed
Stereo Audio outputs for both Left and Right Channels
Video output can be composite video or VGA
Can drive video to any bulkhead monitor of any size
NTSC and PAL video formats are supported
   5.5 Remote Control Unit (RCU)

See FIG. 12.

The RCU is a compact, versatile and easily customizable Remote Control for the CMS. This unit allows control of any cabin function connected to the network such as; lighting and environmental control systems, audio & video source equipment and channel selections for cabin monitors and speakers. The RCU uses the same base hardware and display as the PCU. The PCU is re-packaged into a portable housing, a battery pack is added and the headset Jack is removed, thereby creating an RCU. With this unique feature the GUI can be identical to the PCU thereby simplifying the user experience.

### DESCRIPTION AND OPERATION OF ALTERNATE EMBODIMENT (WIRED)

6. Wired System Overview

The CMS can be configured for wired Audio/Video distribution. In this configuration the Passenger Control Units (PCU) 302, Cabin Switch Panels (CSP) 306, Audio/Video Decoder Units (VDU) 308, and Enunciator Panel 310 communicate with the Cabin Control Unit (CCU) 102 via an IEEE802.3 (Ethernet) network running IPTV protocols. The environmental controls remain wired interfaces to the lighting and heating/cooling systems. With a wired system the PCU 302, CSP 306 and VDU 308 receive both data and power from the Data Switch Unit 304, using Power over Ethernet (PoE) technology.

6.1 Audio Distribution (Wired)

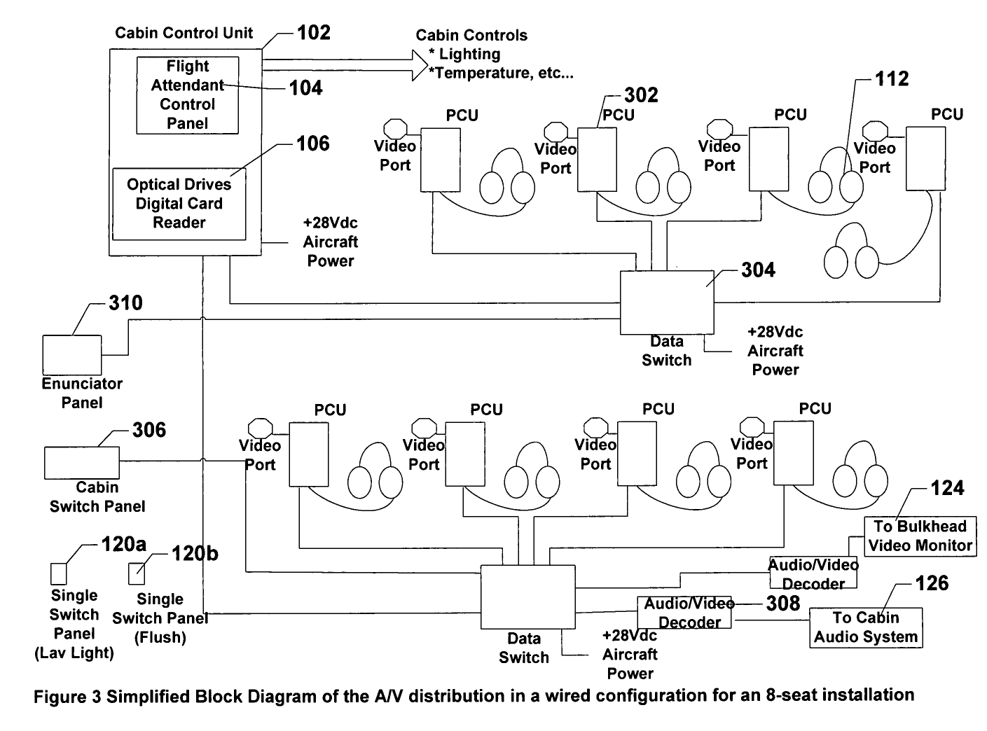

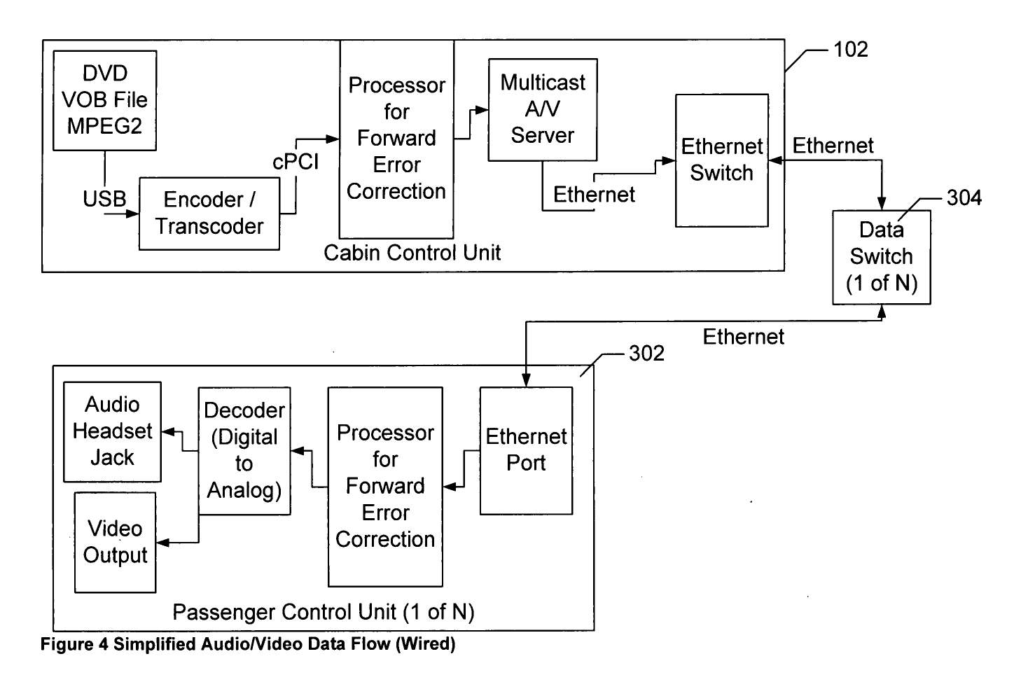

See FIG. 3 and FIG. 4.

Same as in the wireless section except instead of the audio going to the Wireless Access Point FIG. 1 (WAP) 114, it is wired to the Data Switch Unit 304. Also, all of the PCUs 302, CSPs 306 and VDUs 308 are identical to their wireless counterparts PCU 108, CSP 118 & VDU 122 except in two areas;
FIG. 12 internal radio 1232 and antenna 1236 are not used
The wired versions receive their power from the Data Switch Unit 304 using Power over Ethernet (PoE).

6.2 Video Distribution (Wired)

See FIG. 3 and FIG. 4.

Same as in the wireless section except instead of the video going to the Wireless Access Point (WAP) 114, it is wired to the Data Switch Unit 304.

Also, all of the PCUs 302, CSPs 306 and VDUs 308 are identical to their wireless counterparts PCU 108, CSP 118 & VDU 122 except in two areas;
FIG. 12 internal radio 1232 and antenna 1236 are not used
The wired versions receive their power from the Data Switch Unit 304 using Power over Ethernet (PoE).

Also, while not shown in the wired system drawings, if someone wanted to add a remote control to the wired system they would add in the WAP 114 and the Remote 130 and that functionality could be added.

Also, nothing prevents a hybrid system from being used. That is, some parts are wired and some parts are wireless. It is mostly dependent on the vehicle configuration and the end result desired.

6.3 Command Control Flow (Wired)

Same as in the wireless section except instead of the commands being sent wirelessly through the Wireless Access Point (WAP) 114, they are routed through the Data Switch Unit 304 using physical cabling.

6.4 System Components

6.4.1 Passenger Control Unit (Wired)

Same features and functionality as the wireless PCU FIG. 12 internal radio 1232 and antenna 1236 are not used.
Using Power over Ethernet (PoE) power is fed to the unit along with data in the same cable assembly
   6.4.2 Cabin Switch Panel (CSP) (Wired)

Same features and functionality as the wireless CSP except FIG. 12 internal radio 1232 and antenna 1236 are not used.

6.4.3 AudioNideo Decoder Unit (VDU) (Wired)

Same features and functionality as the wired VDU except FIG. 12 internal radio 1232 and antenna 1236 are not used.

6.4.4 Data Switch Unit (DSU) (Wired)

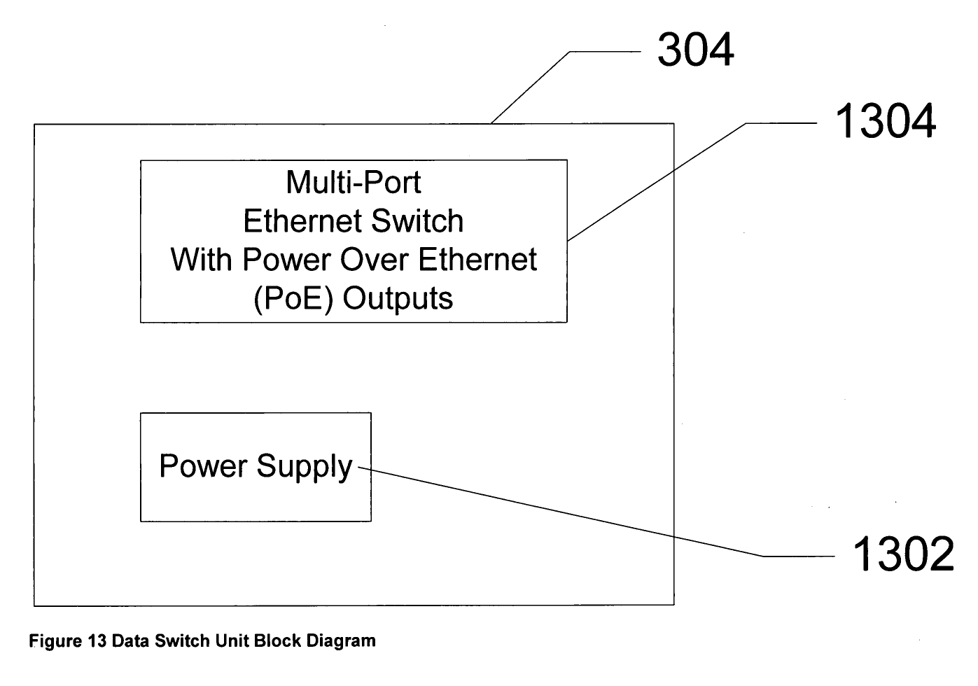

The DSU 304 shown in FIG. 13 is a compact Ethernet Data Switch and Power Supply used for providing data distribution and power to Audio/Video Decoder Units (VDU) 308, Passenger Control Units (PCUs) 302, and Cabin Switch Panels (CSP) 310.

Features:
Compact multi-port Ethernet Switch 1304
Integral Power Supply 1302 for powering both power and data to remote PCU's, VDU's and/or Switch Panels using Power-Over-Ethernet (PoE) technology

What is claimed is:

1) A data management system for supplying multi-cast data to a plurality of devices comprised of:
(a) one or more data sources,
(b) one or more multi-cast data streamers,
(c) a data network,
(d) a multi-cast receiver at each receiving unit,
(e) a means of selecting which multi-cast data channel is decoded,
(f) a means of converting the digital multi-cast data into a format recognizable to the user

2) The data management system in claim 1 wherein the data is audio content.

3) The data management system in claim 2 wherein the audio is only broadcast onto a multi-cast stream when a passenger or crewmember selects it.

4) The data management system in claim 1 wherein the data is video content.

5) The data management system in claim 4 wherein the video is only broadcast onto a multi-cast stream when a passenger or crewmember selects it.

6) The data management system in claim 1 wherein the data is aircraft data information.

7) The data management system in claim 6 wherein the aircraft data is only broadcast onto a multi-cast stream when a passenger or crewmember selects it.

8) A data management system for carrying audio, video, control and status information comprised of:
(a) one or more data sources,
(b) a data switch that also functions as a power supply for connected peripherals,
(c) a data network utilizing power-over-ethernet technologies,
(d) unit-to-unit cabling that is comprised of a single cable comprised of four wires with these four wires carrying both power and data
(d) a receiver at each receiving unit,
(e) a means of selecting which data is desired,
(f) a means of converting the digital data into a format recognizable to the user.

9) The data management system in claim 8 wherein the unit-to-unit cabling is comprised of an eight wire cable.
